(19) United States
(12) Patent Application Publication
(10) Pub. No.: US 2010/0225279 A1
(43) Pub. Date: Sep. 9, 2010

(54) PORTABLE ELECTRONIC DEVICE AND CHARGING SYSTEM USING THE SAME

(75) Inventor: CHIA-HUI LIAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/430,993

(22) Filed: Apr. 28, 2009

(30) Foreign Application Priority Data
Mar. 9, 2009 (CN) 200910300756.7

(51) Int. Cl. H02J 7/00

(52) U.S. Cl. 320/137

(57) ABSTRACT

A portable electronic device includes a first process control unit to send and receive a control signal, a battery electrically connected to the first process control unit to provide electrical power for the first process control unit, and a charging unit to charge the battery. The charge control unit comprises a charging procedure to control a work mode of the charging unit. A switch is electrically connected to the first process control unit and the charging unit to decide whether the charging unit works or not, and a first connecting port electrically connected to the first process control unit and the switch, to transmit a control signal, a digital signal and a power signal.

### BACKGROUND

1. Technical Field

The present disclosure relates to portable electronic devices, and particularly, to a charging system using the portable electronic device and an external electronic device.

2. Description of the Related Art

With the development of wireless communication and information processing technologies, portable electronic devices, such as mobile phones and personal digital assistants (PDAs), are now in widespread use.

Portable electronics device may have multimedia capabilities, such as playing music and video, taking pictures, and so on. If a portable electronic device is electrically connected to an external electronic device, such as a projector, to play video, the portable electronic device may easily quickly run out of power. Thus, it may not be convenient and energy efficient to play video files of the portable electronic device via the external electronic device.

What is needed, therefore, is a new portable electronic device and a charging system using the same to overcome the above-described shortcomings.

### BRIEF DESCRIPTION OF THE DRAWINGS

Many aspects of the present portable electronic device, and a charging system can be better understood with reference to the following drawings. The components in the drawings are not necessarily drawn to scale, the emphasis instead being placed upon clearly illustrating the principles of the present portable electronic device and the charging system. Moreover, in the drawings, like reference numerals designate corresponding parts throughout the several views.

FIG. 1 is an isometric view of an embodiment of a portable electronic device connected to an external electronic device in use.

FIG. 2 is a chart of a charging system of the portable electronic device with the external electronic device shown in FIG. 1.

FIG. 3 is a bottom plane view of a first external plug of the portable electronic device shown in FIG. 1.

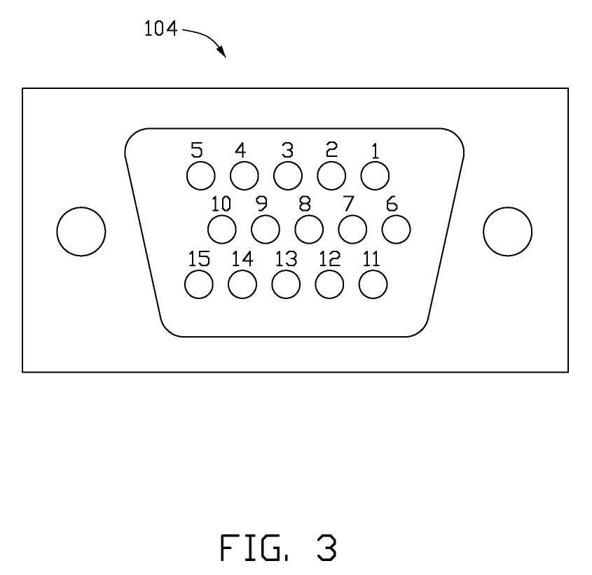

FIG. 4 is a chart of a first embodiment of a charging method of the portable electronic device shown in FIG. 1.

FIG. 5 is a chart of a second embodiment of a charging method of the portable electronic device shown in FIG. 1.

### DETAILED DESCRIPTION

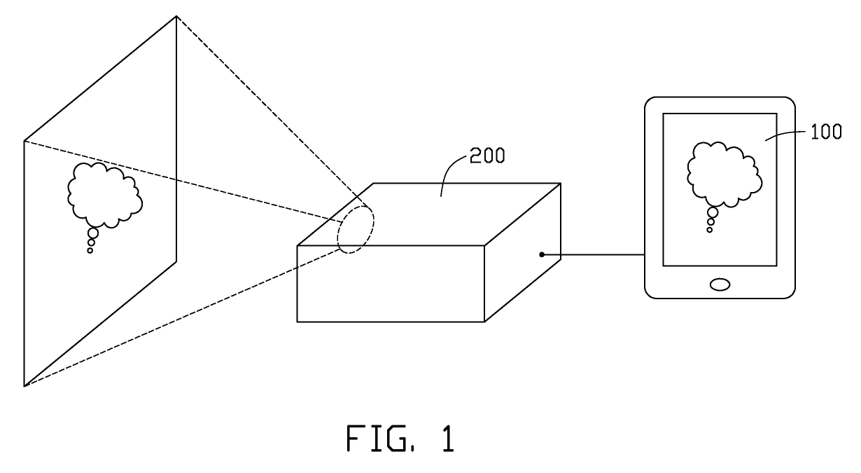

Referring to FIG. 1, an embodiment of a portable electronic device 100 is electrically connected to an external electronic device 200. The portable electronic device 100 may be a mobile phone or a personal digital assistant (PDA). The external electronic device 200 may be a projector or a notebook personal computer. In this embodiment, the portable electronic device 100 is a mobile phone, and the external electronic device 200 is a projector. The portable electronic device 100 is electrically connected to the external electronic device 200. The external electronic device 200 projects images from the portable electronic device 100, while the portable electronic device 100 is charged at the same time.

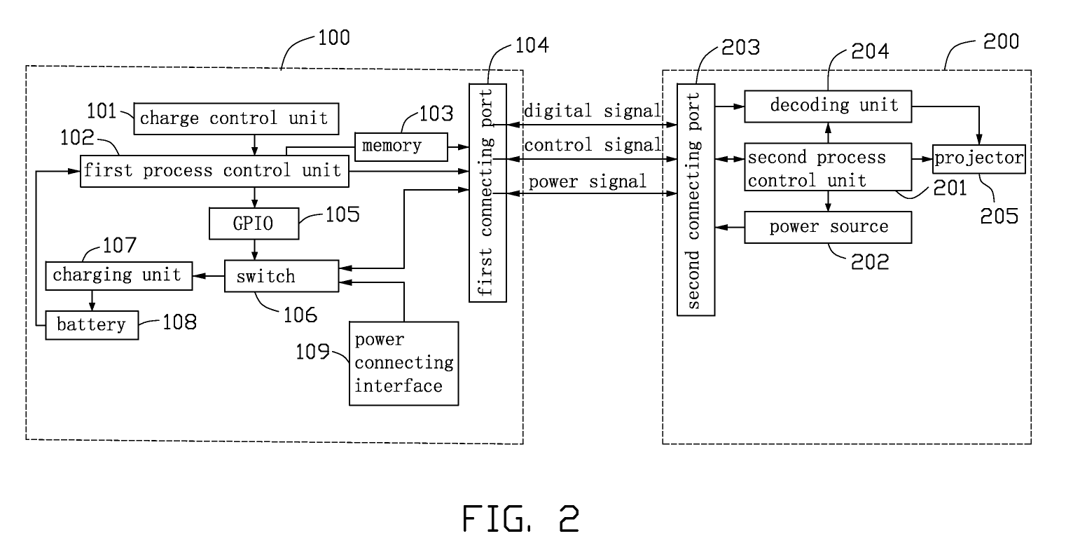

Referring to FIG. 1 and FIG. 2, a charging system includes the portable electronic device 100 and the external electronic device 200.

The portable electronic device 100 includes a charge control unit 101, a first process control unit 102, a memory 103, a first connecting port 104, a general purpose input output (GPIO) port 105, a switch 106, a charging unit 107, a battery 108, and a power connecting interface 109.

The first process control unit 102 is electrically connected to the charge control unit 101, the memory 103, the first connecting port 104 and the GPIO port 105 for receiving and sending control signals. The charge control unit 101 includes a charging procedure for selecting work modes, such as a charging mode, a digital transmitting mode, and a charging and digital transmitting mode. The charge control unit 101 is electrically connected to the first process control unit 102 for controlling the work mode of the charging unit 107. The charging unit 107 is electrically connected to the battery 108 for charging the battery 108. The battery 108 is configured for providing electrical power to the first process control unit 102. The memory 103 stores digital documents.

The first connecting port 104 is configured for sending control signals, digital signals, and power signals. The first connecting port 104 is selected from the group consisting of video graphics array (VGA), digital visual interface (DVI), and high definition multimedia interface (HDMI). In the illustrated embodiment, referring to Table 1, the first connecting port 104 is a VGA port. The first connecting port 104 includes an inter-integrated circuit (I²C) data pin 12 and an I²C clock pin 15 to send or receive the control signals.

TABLE 1
Pin layout of VGA

| Pin Number | Description |
|---|---|
| 1 | Red video |
| 2 | Green video |
| 3 | Blue video |
| 4 | Not connected |
| 5 | Ground |
| 6 | Red return |
| 7 | Green return |
| 8 | Blue return |
| 9 | +5 V (DDC) |
| 10 | Sync Ground |
| 11 | Not connected |
| 12 | I²C data |
| 13 | Horizontal sync |
| 14 | Vertical sync |
| 15 | I²C clock |

The GPIO port 105 provides extra monitor and control capabilities for the first process control unit 102. The switch 106 is electrically connected to the GPIO port 105, the charging unit 107 and the power connecting interface 109 for detecting the working states of the charging unit 107. The power connecting interface 109 of the portable electronic device 100 may be electrically connected to an external power to charge the battery 108 directly. It is to be understood that, the GPIO port 105 and the power connecting interface 109 can be omitted without affecting the scope of the present disclosure.

The external electronic device 200 includes a second process control unit 201, a power source 202, a second connecting port 203, a decoding unit 204 and a projecting unit 205. The second process control unit 201 is electrically connected to the power source 202, the second connecting port 203, the decoding unit 204 and the projecting unit 205 for receiving and sending control signals. The power source 202 provides electrical power to the second process control unit 201. The second connecting port 203 is electrically connected to the first connecting port 104 for transmitting control signals, digital signals, and power signals. The second connecting port 203 includes an inter-integrated circuit (I²C) data pin and a I²C clock pin to send or receive control signals. The second connecting port 203 is selected from the group consisting of video graphics array (VGA), digital visual interface (DVI), and high definition multimedia interface (HDMI). In the illustrated embodiment, the second connecting port 203 is a VGA port.

The decoding unit 204 is electrically connected to the second process control unit 201 and the projecting unit 205. The decoding unit 204 is operable to decode the digital signals from the portable electronic device 100, and then sending decoded signals to the projecting unit 205. The projecting unit 205 is operable to project the decoded signals from the decoding unit 204.

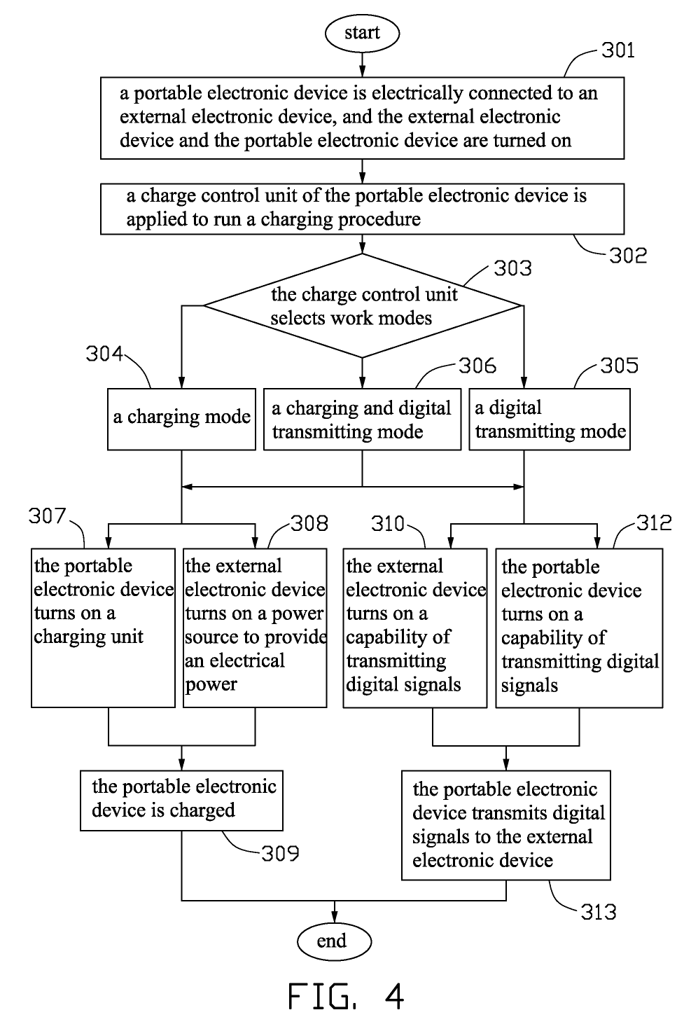

Referring to FIG. 4, a first embodiment of a charging method of the portable electronic device 100 performed with the external electronic device 200, includes following steps.

In step 301, the portable electronic device 100 is electrically connected to the external electronic device 200, and the external electronic device 200 and the portable electronic device 100 are turned on.

In step 302, the charge control unit 101 of the portable electronic device 100 is applied to run the charging procedure.

In step 303, the charge control unit 101 selects the work modes including the charging mode 304, the digital transmitting mode 305, and the charging and digital transmitting mode 306.

Depending on the selected mode, the following sub-steps are executed:

If the charging mode 304 is selected, sub-steps 307 and 308 are executed at the same time. In sub-step 307, the charge control unit 101 sends a control signal to the first process control unit 102, to control the switch 106 to turn on the charging unit 107. In sub-step 308, the first process control unit 102 sends a control signal to the second process control unit 201 of the external electronic device 200, to control the power source 202 to provide electrical power to the battery 108 via the charging unit 107. Finally, in step 309, the portable electronic device 100 is charged.

If the digital transmitting mode 305 is selected, sub-steps 310 and 312 are executed together. In sub-step 312, the charge control unit 101 sends a control signal to the first process control unit 102 to transmit digital signals to the external electronic device 200. In sub-step 310, the first process control unit 102 sends a control signal to the second process control unit 201 to receive digital signals to be projected by the projecting unit 205. Finally, in step 313, the portable electronic device 100 transmits digital signals to the external electronic device 200.

If the charging and digital transmitting mode 306 is selected, sub-steps 307, 308, 310, and 312 are executed together.

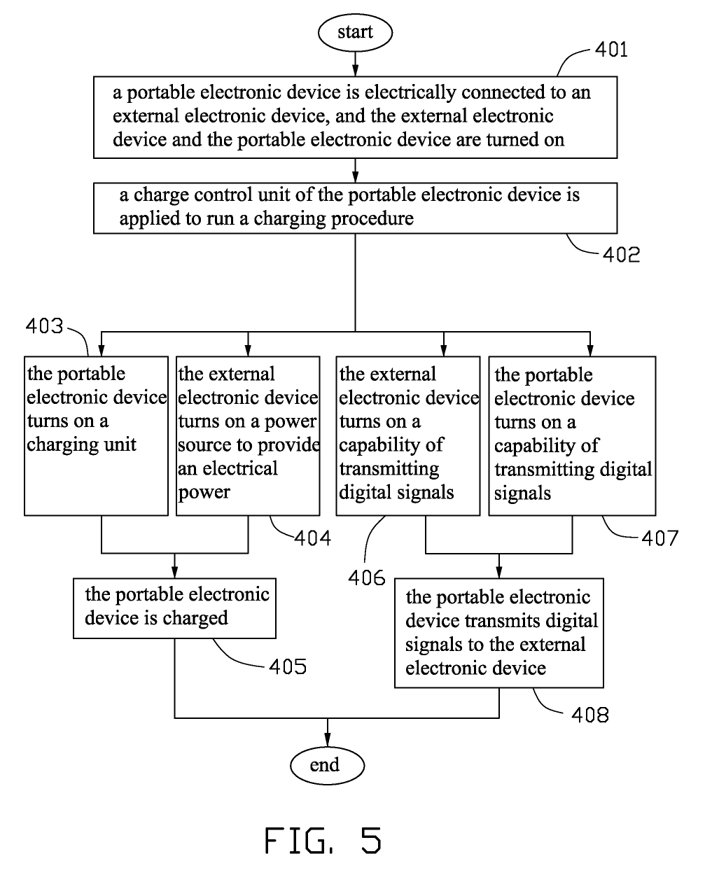

Referring to FIG. 5, a second embodiment of a charging method of the portable electronic device 100 performed with the external electronic device 200, includes following steps.

In step 401, the portable electronic device 100 is electrically connected to the external electronic device 200, and the external electronic device 200 and the portable electronic device 100 are turned on.

In step 402, the charge control unit 101 of the portable electronic device 100 is applied to run the charging procedure.

After step 402, sub-steps 403, 404, 406, and 407 are executed together. The sub-step 403, 404, 406, and 407 are the same as the sub-steps 307, 308, 310, and 312.

In step 405, the portable electronic device 100 is charged.

In step 405, the portable electronic device 100 transmits digital signals to the external electronic device 200.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. A portable electronic device, comprising:
a first process control unit to send and receive a control signal;
a battery electrically connected to the first process control unit to provide electrical power for the first process control unit;
a charging unit to charge the battery;
a charge control unit comprising a charging procedure, the charge control unit electrically connected to the first process control unit to control a work mode of the charging unit;
a switch electrically connected to the first process control unit and the charging unit for deciding whether the charging unit works or not; and
a first connecting port electrically connected to the first process control unit and the switch to transmit a control signal, a digital signal, and a power signal.

2. The portable electronic device of claim 1, further comprising a general purpose input output port electrically connected to the first process control unit and the switch.

3. The portable electronic device of claim 1, wherein the first connecting port is selected from the group consisting of video graphics array, digital visual interface, and high definition multimedia interface.

4. The portable electronic device of claim 3, wherein the first connecting port is a video graphics array port comprising an inter-integrated circuit data pin and an inter-integrated circuit clock pin to send or receive the control signals.

5. The portable electronic device of claim 1, further comprising a power connecting interface electrically connected to the switch, to be electrically connected to an external power to charge the battery directly.

6. The portable electronic device of claim 1, wherein the work modes are selected from the group consisting of a charging mode, a digital transmitting mode, and a charging and digital transmitting mode.

7. A charging system, comprising:
a portable electronic device comprising a first process control unit, a battery, a charging unit, a switch, a first and a first connecting port; and
an external electronic device comprising a second process control unit, a power source and a second connecting port,
wherein the first process control unit and the second process control unit are operable to send and receive a control signal; the battery is electrically connected to the first process control unit to provide electrical power for the first process control unit; the charging unit is operable to charge the battery; the charge control unit comprises a charging procedure, the charge control unit is electrically connected to the first process control unit to control a work mode of the charging unit; the switch is electrically connected to the first process control unit and the charging unit to decide whether the charging unit works or not; the first connecting port is electrically connected to the first process control unit and the switch to transmit a control signal, a digital signal and a power signal; and the second connecting port is electrically connected to the second process control unit, the power source and the first connecting port, to transmit a control signal, a digital signal and a power signal.

8. The charging system of claim 7, further comprising a general purpose input output port electrically connected to the first process control unit and the switch.

9. The charging system of claim 7, wherein the first connecting port is selected from the group consisting of video graphics array, digital visual interface, and high definition multimedia interface.

10. The portable electronic device of claim 9, wherein the first connecting port is a video graphics array port comprising an inter-integrated circuit data pin and an inter-integrated circuit clock pin to send or receive the control signals.

11. The charging system of claim 7, further comprising a power connecting interface electrically connected to the switch, to be electrically connected to an external power to charge the battery directly.

12. The portable electronic device of claim 7, wherein the work modes are selected from the group consisting of a charging mode, a digital transmitting mode, and a charging and digital transmitting mode.
